(19) United States
(12) Patent Application Publication
(10) Pub. No.: US 2017/0270443 A1
(43) Pub. Date: Sep. 21, 2017

(54) Contextual Skill Management Using a Hypergraph

(71) Applicant: ADP, LLC, Roseland, NJ (US)

(72) Inventors: Jason F. Melo, Hastings-on-Hudson, NY (US); Daniel Daehyun Kim, Plainview, NY (US); Siobhan Loughman Sabino, Manalapan, NJ (US)

(21) Appl. No.: 15/071,432

(22) Filed: Mar. 16, 2016

(51) Int. Cl. G06Q 10/06; G06F 17/30

(52) U.S. Cl. CPC G06Q 10/0639; G06F 17/30958; G06F 17/30979

(57) ABSTRACT

A method and apparatus for identifying skills in an organization. An information management system comprises a hypergraph and a skill analyzer. The hypergraph comprising influence objects; edges, wherein a first portion the edges connect influence objects to objects for people in the organization and a second portion of the edges connect the influence objects to the objects for the skills for the people; and a group of influence edges connecting the first portion of the edges to the second portion of the edges to each other in which the group of influence edges are for a group of influences on the skills present in an organization. The skill analyzer identifies the group of influences on a skill in the skills in the organization using on a group of influence objects in the hypergraph, enabling performing an operation for the organization based on the influences on the skills identified.

### CROSS-REFERENCE TO RELATED APPLICATIONS

This application is related to the following patent applications: entitled “Review Management System”, Ser. No. ______, attorney docket no. E52015023-2; and entitled “Marketing Management System”, Ser. No. ______, attorney docket no. E52015023-3; filed even date hereof and assigned to the same assignee. Each of the aforementioned applications is incorporated herein by reference in its entirety.

### BACKGROUND INFORMATION

1. Field

The present disclosure relates generally to an improved computer system and, in particular, to a method and apparatus for accessing information in a computer system. Still more particularly, the present disclosure relates to a method and apparatus for analyzing information about skills for an organization in a computer system.

2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance, wellness plans, and other programs and organizations using an information system. As another example, a research department in an organization may use an information system to store and analyze information to research new products, analyze products, or for other suitable operations. As yet another example, an information system may be used to hire new employees, assign employees to projects, perform reviews for employees, and other suitable operations for the organization.

Currently used information systems include databases that store information about the organization. For example, these databases store information about employees, products, research, product analysis, business plans, and other information about the organization.

Information about the employees may be accessed to perform various operations within an organization. For example, if a manager desires to create a special team for a new project, the manager may review information about the employees and their skill levels in the organization. The manager may also search databases for the organization and identify information about social networking connections among the employees within the organization.

This information is used to manage employees. An important part of managing a team of employees includes managing team dynamics and networking relationships and influences among employees. The information obtained from the information system, however, may not always predict potential influences among employees. A technical challenge is present with dynamically storing the levels of influences of an employee in a database.

For example, identifying levels of influence for an employee is often subjective. Influences build up over time. Existing databases do not adequately address the dynamic nature of influences.

As a result of existing technology not supporting the recording of influences in a useful manner, companies are unable to maximize utilization of their resources. Under existing technology, influences may be stored in a database as static elements, without the ability to store each underlying influence to compare the aggregates of influences.

Therefore, it would be desirable to have a method and apparatus that take into account at least some of the issues discussed above, as well as other possible issues. For example, it would be desirable to have a method and apparatus that overcome a technical problem with storing influences among people and objects.

### SUMMARY

An embodiment of the present disclosure provides an information management system. The information management system comprises a hypergraph and a skill analyzer. The hypergraph comprises influence objects and the hypergraph comprises edges. A first portion of the edges connects influence objects to objects for people in the organization and a second portion of the edges connects the influence objects to the objects for the skills for the people. A group of influence edges connects the first portion of the edges to the second portion of the edges to each other in which the group of influence edges are for a group of influences on the skills present in an organization. The skill analyzer identifies the group of influences on a skill in the skills in the organization using the group of influence objects in the hypergraph, enabling performing an operation for the organization based on the influences on the skills identified.

A further illustrative embodiment of the present disclosure provides a method for identifying skills in an organization. People and the skills for the people are represented as objects and a group of influencers on the skills as influence objects in a hypergraph. Edges are formed between the influence objects and the objects for the people and between the objects for the people and the objects for the skills for the people in the hypergraph. A group of influence edges are formed that connect the edges to each other based on a group of influences the influencers have on skills for the people. The group of influences on a skill in the skills is identified using the group of influence objects in the hypergraph, enabling performing an operation for the organization based on the influences on the skills for the people in the organization using the influence nodes.

A yet further illustrative embodiment of the present disclosure provides a computer product for identifying skills. The computer program comprises first program code, second program code, third program code, and fourth program code, stored on a computer readable storage media. The first program code represents people and the skills for the people as objects and a group of influencers on the skills as influence objects in a hypergraph. The second program code forms edges between the influence objects and the objects for people and between the objects for the people and the objects for skills for the people in the hypergraph. The third program code forms a group of influences edges connecting the edges to each other based on a group of influences the influencers have on skills for the people. The fourth program code identifies the group of influences on a skill in the skills in the organization using the group of influence objects in the hypergraph, enabling performing an operation for the organization based on the influences on the skills for the people in the organization using the influence nodes.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a block diagram of an information environment in accordance with an illustrative embodiment;

FIG. 2 is a block diagram of an object node in accordance with an illustrative embodiment;

FIG. 3 is a block diagram of an edge node in accordance with an illustrative embodiment;

FIG. 4 is a block diagram of an influence node in accordance with an illustrative embodiment;

FIG. 5 is a block diagram of a database in accordance with an illustrative embodiment;

FIG. 6 is a block diagram of data flow for accessing information in a hypergraph in accordance with an illustrative embodiment;

FIG. 7 is a block diagram of a visualization of a graphical indication of an influence on a skill in a hypergraph in accordance with an illustrative embodiment;

FIG. 8 is an illustration of an influence on a skill in accordance with an illustrative embodiment;

FIG. 9 is another illustration of an influence on a skill in accordance with an illustrative embodiment;

FIG. 10 is an illustration of a visualization of influences on a skill in accordance with an illustrative embodiment;

FIG. 11 is a flowchart of a process for identifying skills in an organization in accordance with an illustrative embodiment;

FIG. 12 is a flowchart of a process for querying a high paragraph in accordance with an illustrative embodiment;

FIG. 13 is a flowchart of a process for displaying a visualization of a hypergraph in accordance with an illustrative embodiment; and

FIG. 14 is a block diagram of a data processing system in accordance with an illustrative embodiment.

### DETAILED DESCRIPTION

The illustrative embodiments recognize and take into account one or more different considerations. For example, the illustrative embodiments recognize and take into account that skills present in an organization may be influenced by people. The illustrative embodiments also recognize and take into account that a person in an organization may have an influence on skills of people that have connections to the person. For example, people reporting to a manager may have a particular skill. The illustrative embodiments yet also recognize and take into account that the skill may be one of relevant skills for working with that manager. The illustrative embodiments recognize and take into account that the skill may be acquired by people while reporting to the manager if those people did not have the skill prior to reporting to the manager.

The illustrative embodiments also recognize and take into account that other factors may influence what skills are present in an organization. For example, a particular position may result in skills being acquired if not already present for people in that position. As a result, the position influences what skills are present.

The illustrative embodiments also recognize and take into account that similar influences may be present from other factors, such as a location, a project, a department, a skill, or some other factor. Thus, knowing influences on skills in an organization may be useful in performing operations for the organization.

The illustrative embodiments yet also recognize and take into account that it would be desirable to have a method and apparatus to identify influences on skills in an organization. Thus, the illustrative embodiments provide a method and apparatus for managing skills in an organization.

In one illustrative example, an information management system comprises a hypergraph and a skill analyzer. The hypergraph comprises influence objects; edges, wherein a first portion the edges connect influence objects to objects for people in the organization and a second portion of the edges connect the influence objects to the objects for the skills for the people; and a group of influence edges connecting the first portion of the edges to the second portion of the edges to each other in which the group of influence edges are for a group of influences on the skills present in the organization. The skill analyzer identifies a group of influences on the a skill in the skills in the organization using a group of influence objects in the hypergraphs, enabling performing an operation for the organization based on the influences on the skills identified.

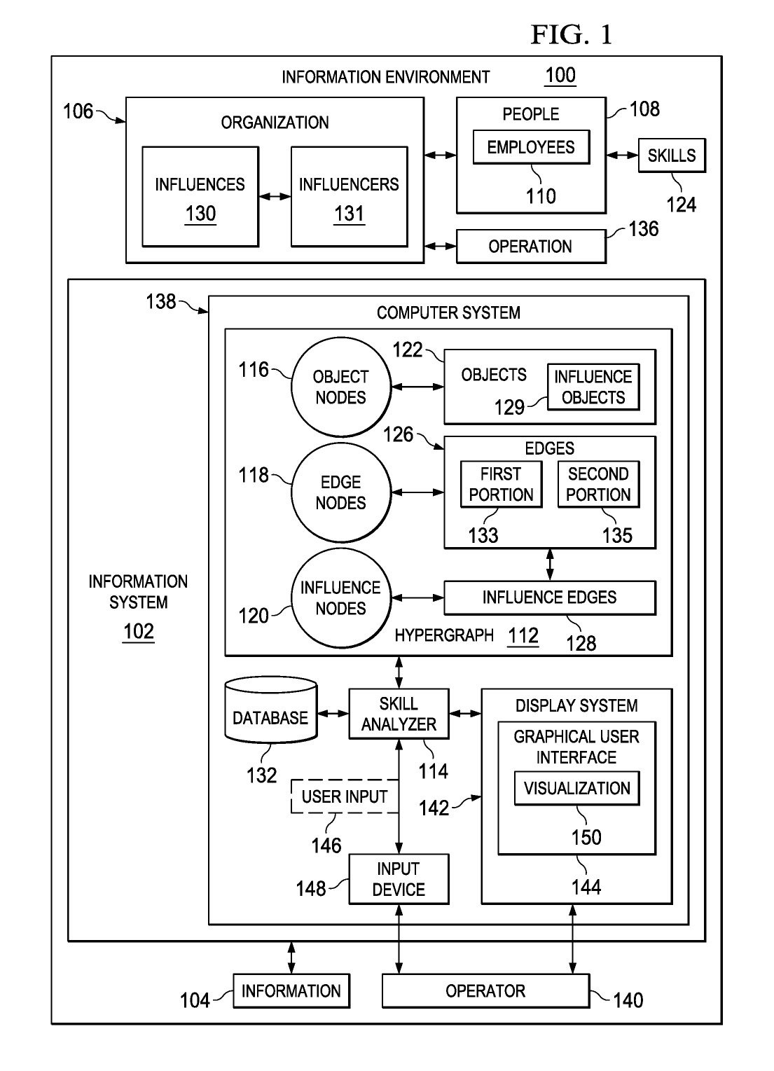

With reference now to the figures and, in particular, with reference to FIG. 1, a block diagram of an information environment is depicted in accordance with an illustrative embodiment. In this illustrative example, information environment 100 includes information system 102. Information system 102 provides access to information 104 for organization 106. The access to information 104 may be at least one of reading, writing, modifying, storing, or deleting information 104.

As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the illustrative example, information 104 may take different forms. For example, information 104 may be information about at least one of people, products, services, business plans, performance reviews, payroll, human resources, benefits administration, business plans, marketing, research, product development, or other suitable information.

In the illustrative example, organization 106 may be selected from one of a company, a partnership, a corporation, a charity, a city, an educational group, a social group, a team, a government entity, or some other suitable type of organization. People 108 in organization 106 may be employees 110 of organization 106. In other illustrative examples, people 108 may be members of organization 106 without being employees 110.

Information system 102 provides access to information 104. Information 104 may be stored in information system 102, other locations external to information system 102, or some combination thereof. For example, information system 102 may be used for at least one of payroll, human resources, benefits administration, research, product analysis, business planning, product development, marketing, or some other suitable purposes in organization 106.

In this illustrative example, information system 102 includes a number of different components. As depicted, information system 102 includes hypergraph 112 and skill analyzer 114.

Hypergraph 112 is a data structure and is used for at least one of storing or organizing some or all of information 104. As depicted, hypergraph 112 comprises objects 122, edges 126, and influence edges 128. Objects 122 are connected to each other by edges 126, and edges 126 are connected to each other by influence edges 128.

In the illustrative examples, objects 122 are stored as object nodes 116, edges 126 are stored as edge nodes 118, and influence edges 128 are stored as influence nodes 120 in database 132. In this manner, object nodes 116 represent objects 122 in organization 106. As depicted, objects 122 include at least one of a person, a skill, a location, a position, a team, a department, or some other type of object in organization 106. In the illustrative example, objects 122 represent people 108 in organization 106 and skills 124 for people 108 in organization 106.

In the illustrative example, a skill in skills 124 is an ability of a person in people 108 to do something with a level of expertise or excellence. The skill may be performed with some level of mastery or competence which may be measured using a standard. For example, a skill in team leadership may be measured using a standard based on one or more of reviews from peers, a test, experience, or some other factor.

In this example, edge nodes 118 represent edges 126 connecting objects 122 for people 108 to each other. Edge nodes 118 also represent edges 126 connecting objects 122 for people 108 and object nodes 116 for skills 124 for people 108 to each other. In other words, edge nodes 118 represent edges 126 that connect people 108 to skills 124 as represented in object nodes 116. As depicted, a group of influence nodes 120 represents a group of influence edges 128 that is for a group of influences 130 on skills 124 present in organization 106.

A group of influence edges 128 means a group of influences 130 is present between edges 126 connected by influence edges 128 based on influences 130 on skills 124. Influencers 131 are things that have influence on the presence of skills 124. Influencers 131 are influence objects 129 in objects 122. Influence objects 129 may be, for example, people, positions, activities, or other types of objects 122 that influence skills 124. The influence may be, for example, the influence objects 129 causing people 108 in objects 122 to acquire skills 124, increase proficiency in skills 124, or other characteristics of skills 124.

For example, influences 130 on skills 124 may be made by some of people 108 on others of people 108 to acquire a group of skills 124. In another example, influence on skills 124 may be caused by influence objects 129 selected from at least one of a position, a team, a department, an activity, a location, or other objects in objects 122 that may have an influence on skills 124. Thus, influence nodes 120 may be used to identify a group of influences 130 on skills 124 caused by influence objects 129.

In this example, first portion 133 of edges 126 connects influence objects 129 to objects 122 or people in organization 106, and second portion 135 of edges 126 connects objects 122 for people to skills 124. First portion 133 of edges 126 is connected to second portion 135 of edges 126 by a group of influence edges 128 in which the group of influence edges 128 is for a group of influences 130 on skills 124. In this example, skills 124 are skills in organization 106.

In this manner, identifying influences 130 on skills 124 may occur using influence edges 128. Identifying influences 130 on skills 124 may include identifying influence objects 129 that are the source of influences 130, in addition to which ones of skills 124 are influenced.

For example, an influence node in influence nodes 120 represents an influence edge in influence edges 128 that connects a first edge with a second edge in edges 126. The first edge connects a first person to a second person in people 108. The second edge connects the second person to a skill in skills 124.

As depicted, the first edge results in the second edge being formed. In this example, a relationship between the first person and the second person results in the second person having the skill. The influence is represented by the influence edge connecting the first edge and the second edge to each other.

In this illustrative example, hypergraph 112 is stored in database 132. Object nodes 116, edge nodes 118, and influence nodes 120 in hypergraph 112 are stored in database 132. Storing edges 126 as edge nodes 118 and influence edges 128 as influence nodes 120 allows representing connections between edges 126 using currently available graph database systems.

Database 132 is an organized collection of information 104. Database 132 may be in a single location or distributed in different locations.

Skill analyzer 114 provides access to information 104 about skills 124. This access may be provided using hypergraph 112 stored in database 132.

For example, skill analyzer 114 identifies influences 130 on skills 124 in organization 106 based on influence nodes 120 in hypergraph 112. This identification of influences 130 enables performing operation 136 for organization 106 based on influences 130 on skills 124 identified. Operation 136 may be, for example, hiring for a position, selecting skills desirable for a new position, making a hiring recommendation, assigning people to a project, assigning people to a team, benefits administration, performing payroll operations, awarding bonuses, awarding promotions, assigning a research project, or some other suitable object.

Skill analyzer 114 may be implemented in software, hardware, firmware or a combination thereof. When software is used, the operations performed by skill analyzer 114 may be implemented in program code configured to run on hardware, such as a processor unit. When firmware is used, the operations performed by skill analyzer 114 may be implemented in program code and data and stored in persistent memory to run on a processor unit. When hardware is employed, the hardware may include circuits that operate to perform the operations in skill analyzer 114.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In this example, skill analyzer 114 may be implemented in computer system 138. Computer system 138 is a hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

Display system 142 is a physical hardware system in computer system 138 and includes one or more display devices on which graphical user interface 144 may be displayed. The display devices may include at least one of a light emitting diode display (LED), a liquid crystal display (LCD), an organic light emitting diode display (OLED), or some other suitable device on which graphical user interface 144 can be displayed.

Operator 140 is a person that may interact with graphical user interface 144 through user input 146 generated by input device 148 in computer system 138. Input device 148 may be, for example, a mouse, a keyboard, a trackball, a touchscreen, a stylus, a motion sensing input device, a cyberglove, or some other suitable type of input device.

As depicted, visualization 150 of hypergraph 112 may be displayed to operator 140 on display system 142. For example, visualization 150 of hypergraph 112 may be generated from object nodes 116, edge nodes 118, and influence nodes 120. Visualization 150 allows operator 140 to visualize influences 130 on skills 124 in organization 106.

For example, a skill in skills 124 may be needed for a position in organization 106. The influence on the skill, with respect to the position, means that the person in the position may not have the skill when placed into the position, but will acquire the skill if the person is to be successful in the position. Being successful in a position may include at least one of being in the position for a selected period of time, receiving desired reviews, receiving a compensation increase, receiving a bonus, receiving an award, receiving a promotion, or some other factor that indicates success.

In the illustrative example, one or more technical solutions are present that overcome a technical problem with identifying relevant skills in an organization. As a result, one or more technical solutions to this technical problem may provide a technical effect in which a more accurate identification of skills may be made. For example, the technical effect may result in identifying skills relevant to a position, a task, an assignment, or some other purpose. As a result, more accurate decisions may be made when skills are involved.

Skill analyzer 114 may be used to identify relevant skills in skills 124 using hypergraph 112 for various purposes. For example, skill analyzer 114 may be used to identify skills that an employee in employees 110 may need for a particular location, position, team, department, or purpose.

With skill analyzer 114, searches of hypergraph 112 may be performed to identify influences 130 on skills 124 for these and other purposes. As a result, a more accurate identification of a relevant skill in skills 124 needed for filling positions, creating teams, hiring new employees, performing evaluations, counseling employees 110, and performing other operations may occur.

Further, object nodes 116, edge nodes 118, and influence nodes 120 provide a technical solution to the technical issue of storing influences that people, positions, activities, and other influence objects 129 have on skills 124 for people 108. The addition of influence edges 128 stored as influence nodes 120 provides a technical solution to store influences 130 in hypergraph 112.

Computer system 138 operates as a special purpose computer system in which skill analyzer 114 in computer system 138 enables identifying skills 124 in a desired manner, such as influences on skills that are in an organization. Skill analyzer 114 allows for increased usefulness of hypergraph 112 through the use of influence nodes 120 that identify influences edges 128 for edges 126, with respect to skills 124. In particular, skill analyzer 114 transforms computer system 138 into a special purpose computer system, as compared to currently available general computer systems that do not have skill analyzer 114.

Computer system 138 performs a transformation of information 104 such that information 104 includes influences 130 between edges 126, with respect to influences 130 on skills 124. These influences are represented by influence edges 128. This addition of influence nodes 120 increases the usefulness of information 104 represented in hypergraph 112 that is not found in current hypergraphs. In other words, skill analyzer 114 and the use of influence nodes 120 provide additional functionality for information 104 in hypergraph 112, with respect to skills 124.

Further, the manner in which information 104 is stored for hypergraph 112 in database 132 located within computer system 138 also makes computer system 138 a special purpose computer. For example, representing edges 126 as edge nodes 118 provides a technical feature in which connections between edges 126 may be made and stored in a similar fashion in which objects 122 are stored as object nodes 116 for hypergraph 112 in database 132. In a similar fashion, influence edges 128 also may be stored in the form of influence nodes 120. This type of representation of edges 126 and influence edges 128 provide a technical advantage over current representations of edges in which information 104 may also be stored in database 132. Examples of information that may be stored in edge nodes 118 and influence nodes 120 are shown in FIG. 3 and FIG. 4 below.

In this manner, computer system 138 operates as a special purpose computer in which skill analyzer 114 may perform analysis on influences 130 by influencers 131 on skills 124 for people 108. This type of analysis is not possible with currently available hypergraphs that do not use the architecture in which edge nodes 118 and influence nodes 120 are used as additional types of nodes in addition to object nodes 116 in hypergraph 112.

In other words, the manner in which information 104 is stored in organized in hypergraph 112 in database 132 enables storing identifications of influences 130. The technical solution involves using influence edges 128 to connect first portion 133 and second portion 135 to each other in a manner that identifies influences 130 by influencers 131. Additionally, object nodes 116 also include influence objects 129 to identify influences 130 on skills 124 for people 108. With these types of data structures, computer system 138 operates as a special purpose computer to provide an ability to identify influences 130 on skills 124 in a manner that may be used to perform real world operations. Those real world operations include operation 136 that may be performed with respect to organization 106.

Further, in another illustrative example, skill analyzer 114 creates a web page including hypergraph 112 and sends the web page to a device for use by operator 140 or some other user. In other words, skill analyzer 114 also may function as a web server. The web page may be sent over a network, such as the Internet, and displayed on a device, such as a mobile phone, a tablet, a laptop computer, a desktop computer, or some other suitable type of hardware device.

Further, skill analyzer 114 may provide many operators access to hypergraph 112 through devices operated by those operators. Each hypergraph generated is customized for the particular query that each of operators may make. As a result, each operator receives a customized web page that contains a hypergraph generated in response to the particular query sent by the operator.

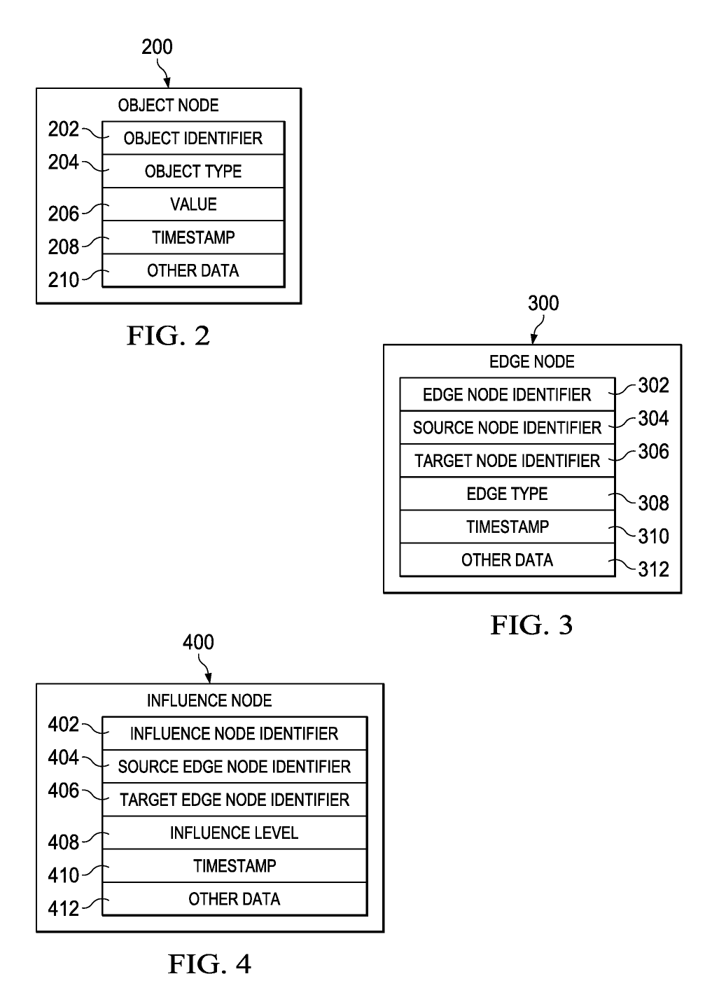

With reference now to FIG. 2, a block diagram of an object node is depicted in accordance with an illustrative embodiment. In the illustrative examples, the same reference numeral may be used in more than one figure. This reuse of a reference numeral in different figures represents the same element in the different figures.

In this illustrative example, object node 200 is an example of an object node in object nodes 116 in FIG. 1. Object node 200 has a number of different fields. As depicted, object node 200 includes object identifier 202, object type 204, value 206, timestamp 208, and other data 210.

Object identifier 202 is a value that uniquely identifies object node 200 from other object nodes. The value is unique within in a hypergraph.

As depicted, object type 204 identifies the type of object for object node 200. For example, object type 204 may be selected from a group comprising a person, a location, a position, a team, a department, a skill, and some other type of object.

In this illustrative example, value 206 may be a number, a string, an alphanumeric value, or in some other suitable format. For example, when object type 204 is a person, value 206 may be the name of the person. As another example, when object type 204 is a skill, value 206 may be the name of the skill.

Timestamp 208 identifies when object node 200 was last changed. Other data 210 may be different for different types of object nodes. For example, other data 210 may include at least one of a level of skill, the time that the skill has been possessed by a person, the specialties for the skill, or other suitable information.

Turning next to FIG. 3, a block diagram of an edge node is depicted in accordance with an illustrative embodiment. In this example, edge node 300 is an example of an edge node in edge nodes 118 in FIG. 1. Edge node 300 is a data structure used for storing information about an edge connecting two object nodes. The edge may be a line.

In the illustrative example, edge node 300 includes a number of different fields. Edge node 300 includes edge node identifier 302, source node identifier 304, target node identifier 306, edge type 308, time stamp 310, and other data 312.

Edge node identifier 302 is a value that uniquely identifies edge node 300 from other edge nodes. The value is unique within a hypergraph.

As depicted, source node identifier 304 identifies a first object node, and target node identifier 306 identifies a second object node connected by the edge, as described by edge node 300. A source node is an object node that has a connection to the target node. In other words, the connection may be one that belongs to the source node.

For example, the target node may be a person that has a skill, which is the source node. In another example, the source node may be a manager, and the target node is an employee that reports to the manager.

In the illustrative example, edge type 308 identifies the type of edge that is present. As depicted, edge type 308 may be selected from a group comprising “reports to”, “possesses”, “located at”, “part of”, or some other suitable type of edge.

For example, edge node 300 may have an employee as a source node and a skill as a target node with edge type 308 being “possesses” to show that the employee possesses the skill. In another example, the source node is an employee and the target node is a building location, and edge type 308 is “located at” to show that the employee is located at the building location.

Time stamp 310 identifies when edge node 300 was last changed. Other data 312 is any other data that may be used to describe the edge.

In FIG. 4, a block diagram of an influence node is depicted in accordance with an illustrative embodiment. In this illustrative example, influence node 400 is an example of an influence node in influence nodes 120 in FIG. 1. Influence node 400 is a data structure for storing information about an association between two edges. In some illustrative examples, the association may also be referred to as an edge, a connector, or a line that connects two edges to each other.

In the illustrative example, this association may be the influence of one edge on another edge, with respect to a skill. For example, a first edge between a person and another object, other than the skill, may result in a second edge between the person and the skill. In other words, the presence of the first edge results in the second edge being present. The influence may be present because the first person values the skill, tasks assigned by the first person to the second person require the skill, or for some other reason that results in the second person having the skill when the second person is connected to the first person.

In the illustrative example, influence node 400 has a number of different fields. As depicted, influence node 400 includes influence node identifier 402, source edge node identifier 404, target edge node identifier 406, influence level 408, timestamp 410, and other data 412.

Influence node identifier 402 is a value that uniquely identifies influence node 400 from other influence nodes. The value of influence node identifier 402 is unique within a hypergraph.

Source edge node identifier 404 identifies a first edge, and target edge node identifier 406 identifies a second edge for which an association between the first edge and the second edge is present. Source edge node identifier 404 identifies a first edge that has an influence on a second edge. The second edge is identified by target edge node identifier 406.

Both edges, the first edge and the second edge, have one object node in common. For example, the first edge identified by source edge node identifier 404 is “reports to” a manager, and the second edge identified by target edge node identifier 406 is “possesses” a skill. The object node in common may be an employee. The employee reports to a manager, represented by one object node, and possesses a skill, represented by another object node.

In this example, influence node 400 identifies an influence of the first edge, which is identified by source edge node identifier 404 on a second edge, which is identified by target edge node identifier 406. Thus, the first edge is a source edge that influences the second edge, which is a target edge. In other words, the first edge influences the presence of the second edge. As depicted, the influence is that the employee possesses the skill because of reporting to the manager.

Influence level 408 identifies the level of influence of the first edge, which is identified by source edge node identifier 404 on the second edge, which is identified by target edge node identifier 406. Influence level 408 indicates the likelihood that the second edge is a result of the first edge being present.

Influence level 408 may be identified in a number of different ways. For example, an operator inputs a value for the likelihood that the second edge occurs because of the first edge.

As another example, a statistical analysis may be made to identify the value of influence level 408. For example, with an employee reporting to a manager that has a skill, an analysis may be made as to how many other employees that report to the same manger have the same skill. This analysis may be made using current employees that report to the manager, past employees that report to the manager, or some combination thereof.

Timestamp 410 identifies when influence node 400 was last changed. Other data 412 may include any other information about the influence.

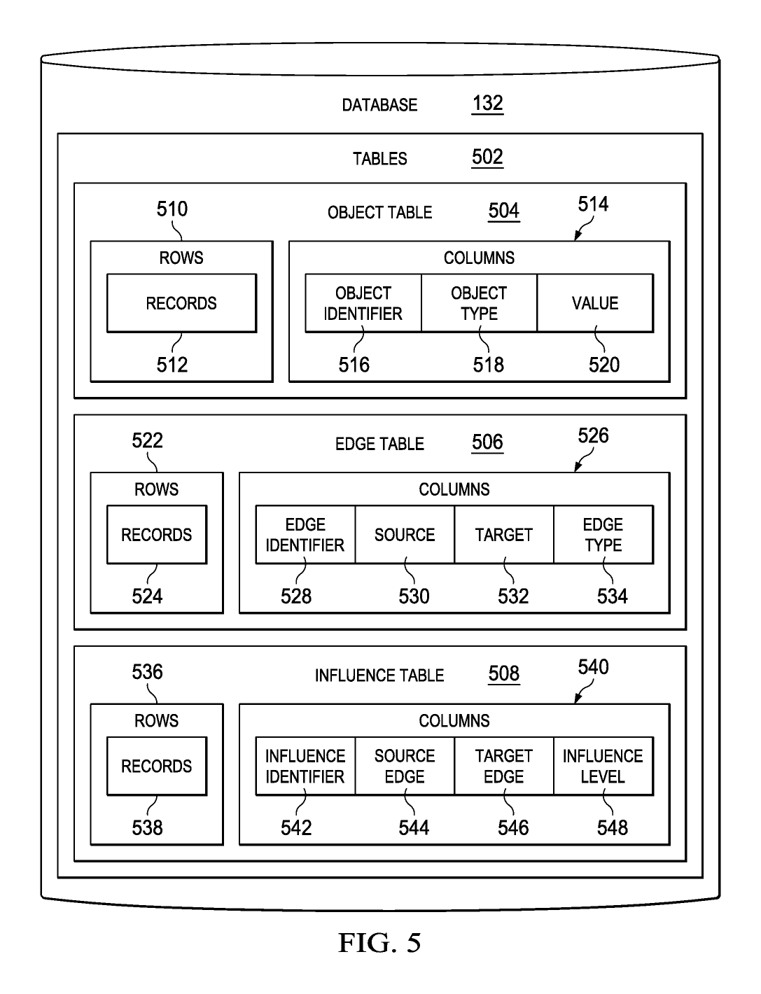

With reference now to FIG. 5, a block diagram of a database is depicted in accordance with an illustrative embodiment. In this illustrative example, an example of one implementation for database 132 in FIG. 1 is shown. As depicted, database 132 includes tables 502. Tables 502 include object table 504, edge table 506, and influence table 508.

Object table 504 includes rows 510 for records 512. Records 512 stores information for object nodes 116 in FIG. 1. Each record in records 512 stores information for a single object node, such as object node 200 in FIG. 2.

Object table 504 also includes columns 514. Each column in columns 514 represents fields in records 512. As depicted, columns 514 include object identifier 516, object type 518, and value 520.

In this illustrative example, edge table 506 includes rows 522 for records 524. Records 524 store information for edge nodes 118 in FIG. 1. Each record in records 524 stores information for a single edge node, such as edge node 300 in FIG. 3.

Edge table 506 also includes columns 526. Each column in columns 526 represents fields in records 524. As depicted, columns 526 include edge identifier 528, source 530, target 532, and edge type 534.

In this illustrative example, influence table 508 includes rows 536 for records 538. Records 538 store information for influence nodes 120 in FIG. 1. Each record in records 538 stores information for a single influence node, such as influence node 400 in FIG. 4.

Influence table 508 also includes columns 540. Each column in columns 540 represents fields in records 538. As depicted, columns 540 include influence identifier 542, source edge 544, target edge 546, and influence level 548.

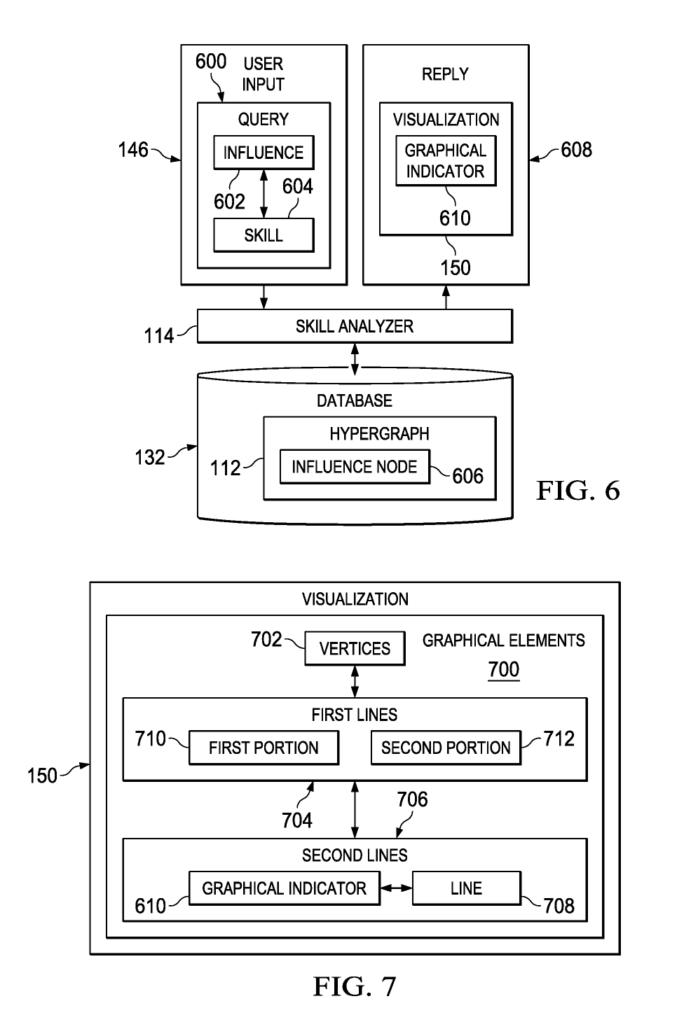

Turning to FIG. 6, a block diagram of data flow for accessing information in a hypergraph is depicted in accordance with an illustrative embodiment. In this illustrative example, skill analyzer 114 receives query 600 in user input 146. Query 600 is for influence 602 in influences 130 in FIG. 1 for skill 604 in skills 124 in FIG. 1.

In response to receiving query 600, skill analyzer 114 searches hypergraph 112 stored in database 132. For example, skill analyzer 114 searches hypergraph 112 for influence node 606 for skill 604.

Influence node 606 includes information about influence 602 on skill 604. The influence may be whether the skill is present because of a position, a manager that the person reports to, a team, a project, or some other factor.

Based on the search, skill analyzer 114 returns reply 608, identifying influence 602 on skill 604. Reply 608 indicates that influence 602 on skill 604 is absent when influence node 606 for skill 604 is not found in hypergraph 112. Reply 608 identifies influence 602 on skill 604 when influence node 606 is found in hypergraph 112.

Reply 608 may take various forms. For example, reply 608 may be text, a report, or some other form that provides an identification of influence 602 on skill 604. In another example, reply 608 may take the form of visualization 150 of hypergraph 112 in FIG. 1 with graphical indicator 610 for influence 602 identified for skill 604.

With reference now to FIG. 7, a block diagram of a visualization of a graphical indication of an influence on a skill in a hypergraph is depicted in accordance with an illustrative embodiment. In this illustrative example, visualization 150 for hypergraph 112 generated in response to query 600 is received by skill analyzer 114 to reflect reply 608, which is generated by skill analyzer 114 in FIG. 6. As depicted, graphical elements 700 are in visualization 150 for object nodes 116, edge nodes 118, and influence nodes 120 in FIG. 1. These elements may also represent objects 122, edges 126, and influence edges 128 in FIG. 1.

For example, graphical elements 700 include vertices 702 that visually represent object nodes 116 in FIG. 1. First lines 704 connecting vertices 702 are graphical elements 700 that illustrate edges 126 described by edge nodes 118 in FIG. 1. Second lines 706 connect at least some of first lines 704.

In visualization 150 of hypergraph 112 in FIG. 1, a line in first lines 704 may connect two or more of vertices 702. First lines 704 represent edges 126. Also, a line in second lines 706 may connect two or more of first lines 704.

First portion 710 of first lines 704 connects vertices 702 for influence objects with vertices for the people. Second portion 712 of first lines 704 connects vertices 702 for objects for people to vertices 702 for the skills.

Second lines 706 connect first portion 710 of first lines 704 to second portion 712 of first lines 704 when influences on skills are present. Second lines 706 represent influence edges 128.

In this illustrative example, visualization 150 includes graphical indicator 610 for line 708 in second lines 706 that graphically indicates influence 602 on skill 604 in FIG. 6. The graphical indicator may be selected from at least one of color, bolding, line thickness, text, an image, flashing, an icon, animation, or some other graphical indicator that draws the attention of someone viewing visualization 150 on display system 142 in FIG. 1 to line 708.

The illustration of information environment 100 and the different components shown in FIGS. 1-7 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, hypergraph 112 may be stored in other forms other than as records in database 132. For example, the information in object nodes 116, edge nodes 118, and influence nodes 120 may be stored in a matrix, a flat file, a table, a linked list, or in some other suitable type of data structure.

In still another illustrative example, operator 140 may access information 104 in hypergraph 112 through a client data processing system, such as a tablet, a mobile phone, a laptop computer, a desktop computer, or some other suitable device that is in communication with skill analyzer 114 in computer system 138. This client data processing system may be considered part of computer system 138 or a separate data processing system.

As another example, other data 210 in object node 200 in FIG. 2, other data 312 in edge node 300 in FIG. 3, and other data 412 in influence node 400 in FIG. 4 are optional and may be omitted in some illustrative examples.

The illustration of database 132 in FIG. 5 is not meant to imply limitations to the manner in which information for nodes, such as object node 200 in FIG. 2, edge node 300 in FIG. 3, and influence node 400 in FIG. 4, may be stored. For example, other columns may be used in addition to or in place of the ones shown in tables 502 in database 132. For example, additional columns may be included in tables 502 for timestamps or other data that may be used in hypergraph 112 in FIG. 1.

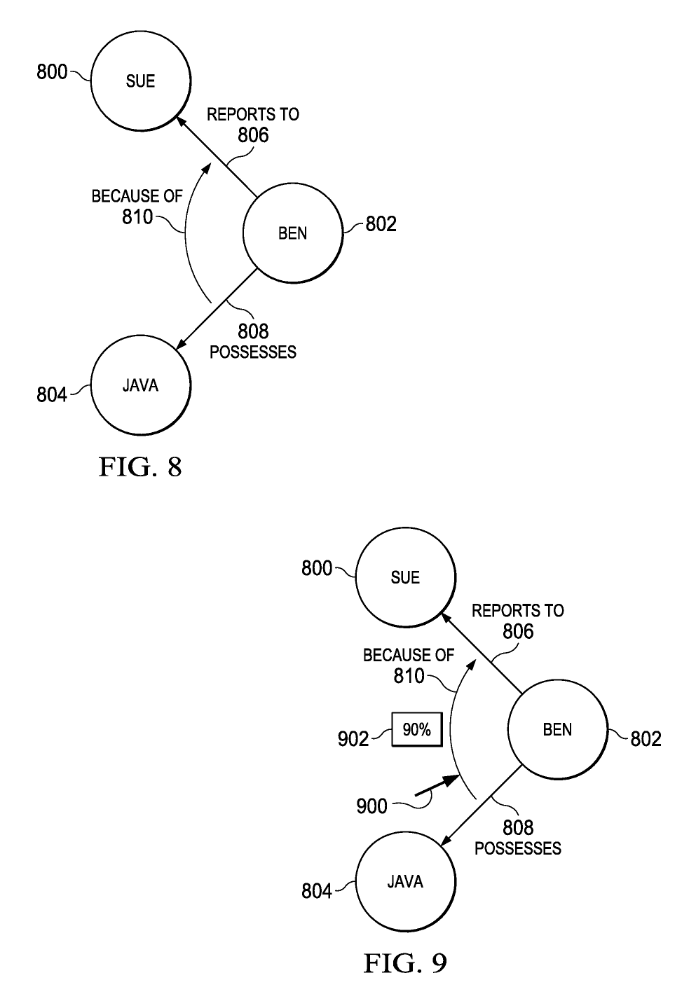

Turning now to FIG. 8, an illustration of an influence on a skill is depicted in accordance with an illustrative embodiment. In this example, a portion of a hypergraph is shown to illustrate an influence on a skill. This portion of the hypergraph is an example of an implementation for hypergraph 112 shown in block form in FIG. 1.

As depicted, Sue 800, Ben 802, and Java 804 are vertices representing objects in an organization. Sue 800 and Ben 802 are people and Java 804 is a skill.

As depicted, “reports to” 806 and “possesses” 808 are lines representing edges. In this example, the relationship of Ben 802 reporting to Sue 800 is shown by “reports to” 806. Additionally, Ben 802 possesses a skill, Java 804, as shown by “possesses” 808.

In this illustrative example, “because of” 810 is an influence edge showing an influence that a first edge, “reports to” 806, has on a second edge, “possesses” 808. In this example, Ben 802 has the skill, Java 804, because Ben reports to Sue 800. As depicted, the influence on Ben 802 reporting to Sue 800 is that Ben 802 possesses Java 804 as a skill. In other words, Sue 800 has influence on Ben 802 having the skill, Java 804. For example, Sue 800 may influence Ben 802 to acquire or increase the level of skill for Java 804. In this example, Sue 800 is an example of an influence object.

Turning next to FIG. 9, another illustration of an influence on a skill is depicted in accordance with an illustrative embodiment. In this example, pointer 900 has been moved over the influence, “because of” 810. As a result, hint 902 is displayed. As depicted, hint 902 shows “90%” as a level of influence. In this illustrative example, the level of influence is the likelihood that “reports to” 806 results in “possesses” 808 for Java 804 as a skill.

A conclusion can be made that people managed by Sue 800 should have Java 804 as a skill. As a result, a less subjective identification of requirements may be made by being able to visualize influences on skills in an organization. The level of influence allows for an evaluation of how likely the skill of a person is influenced by the connection to another person. The influence on the skill may be, for example, acquisition of the skill, increasing the level of proficiency in the skill, or some other characteristic with respect to the skill.

This information may be useful to an employee that desires to work under Sue 800. The employee may query a hypergraph to see that Java 804 is a skill that is of interest to Sue 800 for people who report to Sue 800. The employee may work on obtaining Java 804 if the employee does not already have Java 804 as a skill. In this manner, the employee may become more interesting to Sue 800 if a position opens up under Sue 800.

The illustrations of the visualization of an influence in FIGS. 8-9 are not meant to limit the manner in which visualizations may be formed. For example, other objects other than Sue 800 may be used. Ben 802 may be a member of a department or a team instead of reporting to a person. The result of being a member of a department or a team may influence possessing Java 804 as a skill. As another example, being in a position, a team, a department, a location, or a connection to another object also may influence the presence of a skill. Further, having one skill may influence the presence of another skill.

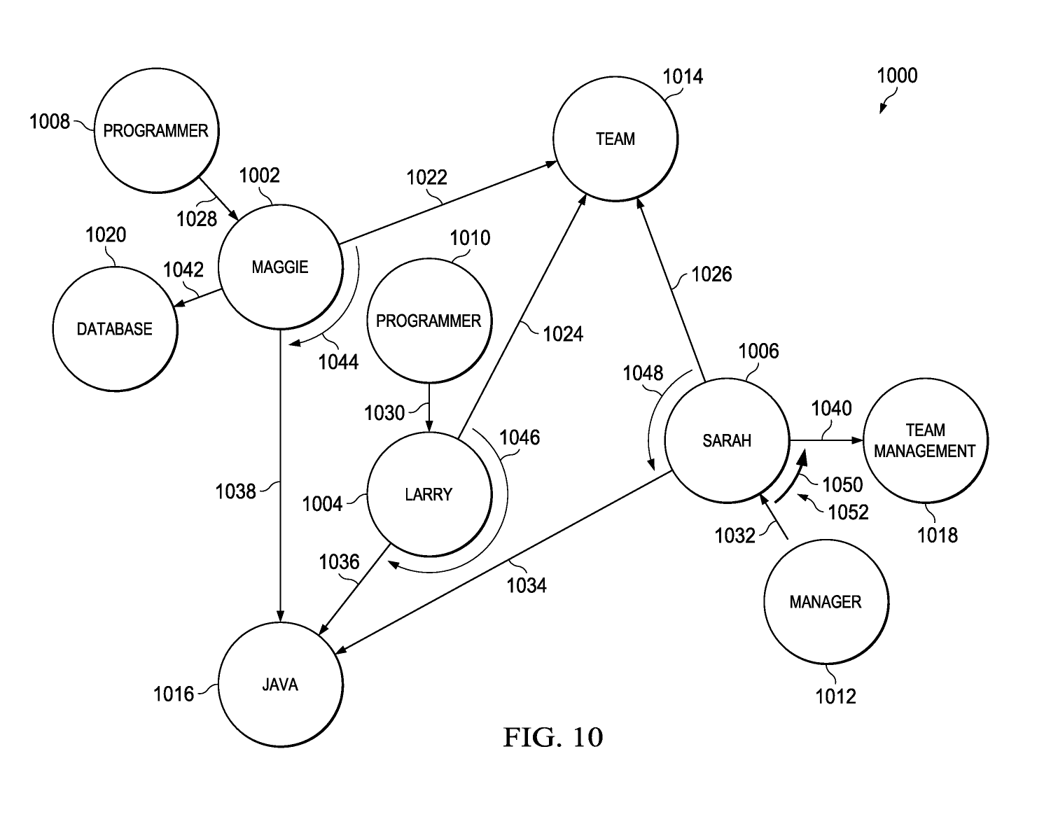

With reference next to FIG. 10, an illustration of a visualization of influences on a skill is depicted in accordance with an illustrative embodiment. In this example, hypergraph 1000 is an example of visualization 150 of hypergraph 112 in FIG. 1 that may be displayed on a display system.

As depicted, hypergraph 1000 includes Maggie 1002, Larry 1004, and Sarah 1006 as people in an organization. The positions in the organization are programmer 1008, programmer 1010, and manager 1012. Team 1014 is present in hypergraph 1000. Skills present in hypergraph 1000 include Java 1016, team management 1018, and database 1020.

As depicted, Maggie 1002, Larry 1004, and Sarah 1006 are part of team 1014 as shown by edge 1022, edge 1024, and edge 1026, respectively. In this illustrative example, Maggie 1002 is programmer 1008 as indicated by edge 1028. Larry 1004 is programmer 1010 as depicted by edge 1030. Sarah 1006 is manager 1012 as indicated by edge 1032.

Sara has Java 1016 as a skill shown by edge 1034. Edge 1036 shows that Larry 1004 has Java 1016 as a skill. Maggie 1002 has Java 1016 as a skill as indicated by edge 1038. Edge 1040 shows that Sara 1006 has team management 1018 as a skill, and edge 1042 shows that Maggie 1002 has database 1020 as a skill.

In this example, Java 1016 is a skill that is influenced from being a part of team 1014. This influence is shown by influence edge 1044, influence edge 1046, and influence edge 1048. Influence edge 1044 shows that edge 1038 occurs because of edge 1022. Influence edge 1046 shows that edge 1036 occurs because of edge 1024. Influence edge 1048 shows that edge 1034 occurs because of edge 1026. In these examples, the influence object is team 1014, which includes people in the form of Maggie 1002, Larry 1004, and Sarah 1006.

As another example, influence edge 1050 also is present. Influence edge 1050 indicates that edge 1040 occurs because of edge 1032. As depicted, team management 1018 is a skill that is needed or results from being manager 1012 as a position. In this example, the influence object is the position.

In this example, a query was made to see whether influences are present for team management 1018 as a skill. As depicted, influence edge 1050 includes graphical indicator 1052. In this illustrative example, graphical indicator 1052 is the line thickness of influence edge 1050.

The line thickness of influence edge 1050 is greater than the line thickness of the lines for influence edge 1044, influence edge 1046, and influence edge 1048. This difference in thickness is used to draw attention to influence edge 1050.

The illustration of hypergraph 1000 in FIG. 10 is not meant to imply limitations to the manner in which hypergraph 112 shown in block form in FIG. 1 may be implemented. Other numbers of objects and types of objects may be represented in hypergraph 1000. For example, hypergraph 1000 also may include objects identifying locations or projects for people.

Further, visualization 150 of hypergraph 112 in FIG. 1 may vary from the visualization depicted for hypergraph 1000. For example, vertices may be shown using geometric shapes other than circles. For example, a hexagon, a square, or some other suitable shape maybe used as vertices to visualize objects.

As another example, other types of graphical indicators in addition to or in place of the line thickness for graphical indicator 1052 may be used. For example, other graphical indicators that may be used in addition to or in place of line thickness include at least one of color, bolding, text, an image, flashing, an icon, animation, or other suitable graphical indicators.

For example, an employee may desire to join team 1014. The employee may research to identify skills required for team 1014 and skills that people on team 1014 learn while on team 1014.

The skills required for the team may be found through requirements or other information published or listed for team 1014. For example, the requirements may be programming generally without any particular language being listed. This skill may be a requirement to join team 1014, but may not reflect which skills may be important to perform well on team 1014.

The skills learned by the people on team 1014 may be identified with queries for influence nodes that show influences on skills that relate to team 1014. For example, influence nodes, displayed as influence edge 1044, influence edge 1046, and influence edge 1048, show associations between edges that reflect Java 1016 as a skill that occurs from being on team 1014. These associations between edges show influences on skills for team 1014 that suggest Java 1016 is needed, even though this skill is not reflected in the list of requirements for team 1014. As another example, influence objects, such as people, activities, location, or other types of influence objects, may also be present.

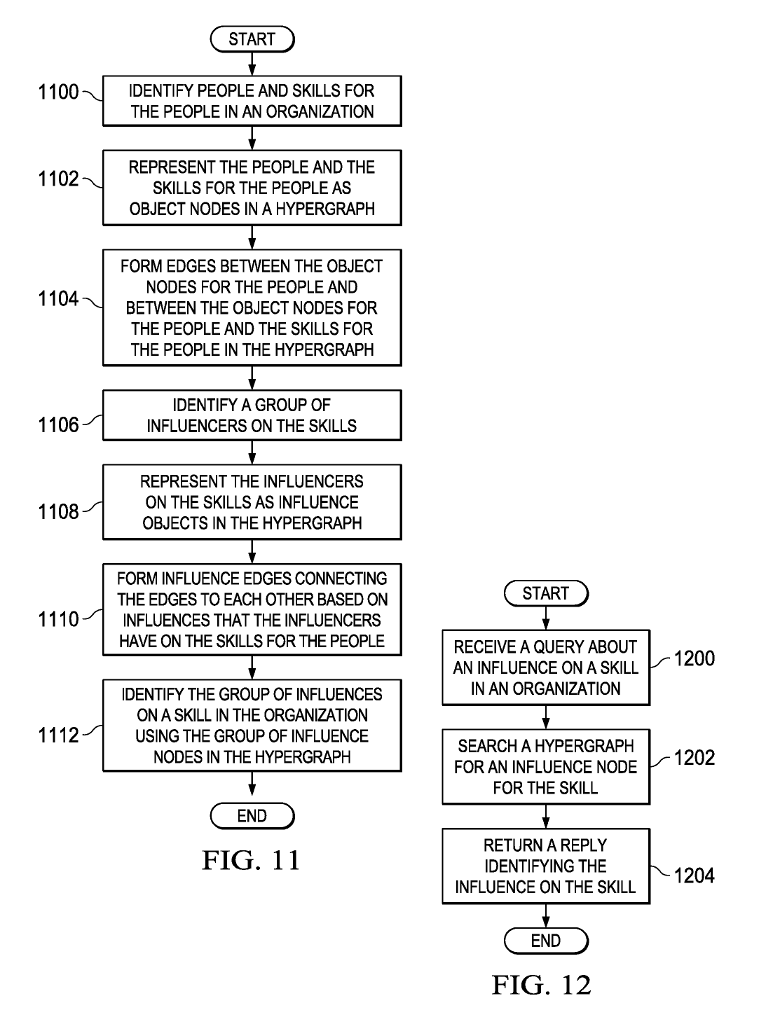

Turning next to FIG. 11, a flowchart of a process for identifying skills in an organization is depicted in accordance with an illustrative embodiment. The process illustrated in FIG. 11 may be implemented in information environment 100 in FIG. 1. For example, the different steps illustrated may be implemented in skill analyzer 114 in FIG. 1.

The process begins by identifying people and skills for the people in an organization (step 1100). The process represents the people and the skills for the people as object nodes in a hypergraph (step 1102). The process forms edges between the object nodes for the people and between the object nodes for the people and the skills for the people in the hypergraph (step 1104).

The process identifies a group of influencers on the skills (step 1106). The group of influencers influences the skills that the people have. In other words, the group of influencers may influence the acquisition of skills, the level of skill, and other characteristics about the skills for the people in the organization. In step 1106, the influencers and the amount of influence may be identified using at least one of user input or statistical analysis. The process represents the influencers on the skills as influence objects in the hypergraph (step 1108).

The process forms influence edges connecting the edges to each other based on influences that the influencers have on skills for the people (step 1110). The connection of the edges to each other may be only some of the edges. For example, in connecting the edges, a group of influence edges connects a first portion of the edges and a second portion of the edges to each other. The first portion of the edges connects influence objects to objects for people and the second portion of the edges connects the objects for people to objects for the skills. The first portion may be one or more edges, and the second portion may be one or more edges.

The influence nodes include information about the influences between the edges. As a result, the influence nodes enable performing an operation for the organization based on the influences on the skills for the people in the organization using the influence nodes.

The process identifies the group of influences on a skill in the organization using the group of influence nodes in the hypergraph (step 1112). The process terminates thereafter.

With reference now to FIG. 12, a flowchart of a process for querying a hypergraph is depicted in accordance with an illustrative embodiment. The process illustrated in FIG. 12 may be implemented in information environment 100 in FIG. 1. For example, the different steps may be implemented in skill analyzer 114 in FIG. 1.

The process begins by receiving a query about an influence on a skill in an organization (step 1200). The process searches a hypergraph for an influence node for the skill (step 1202). The search in step 1202 is made using an identifier for the skill. The identifier may be the name of the skill or some other suitable identifier.

The process returns a reply identifying the influence on the skill (step 1204), with the process terminating thereafter. In the illustrative example, the reply may indicate that the influence on the skill is absent when an influence node for the skill is not identified. Additionally, the reply may take various forms, including a visualization of the high paragraph displayed on the display system. The visualization includes a graphical indicator that identifies the influence on the skill.

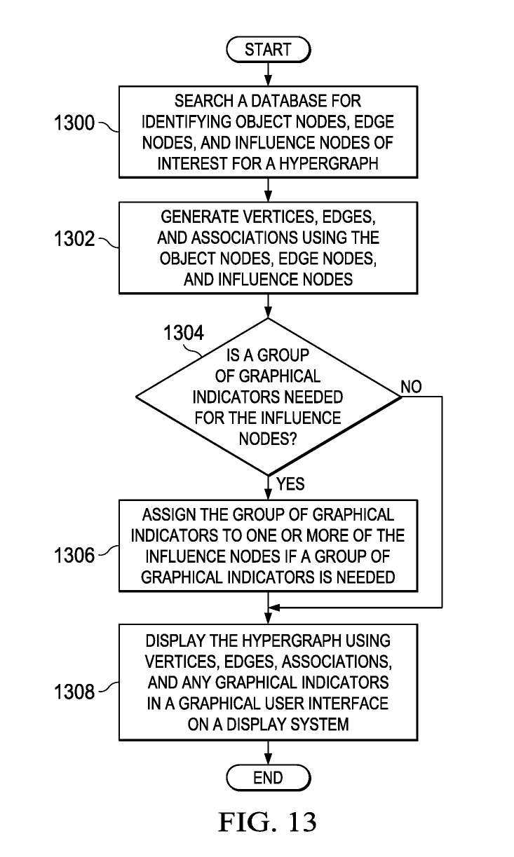

Turning now to FIG. 13, a flowchart of a process for displaying a visualization of a hypergraph is depicted in accordance with an illustrative embodiment. The process illustrated in FIG. 13 may be implemented in skill analyzer 114 to generate and display visualization 150 of hypergraph 112 in FIG. 1.

The process begins by searching a database for identifying object nodes, edge nodes, and influence nodes of interest for a hypergraph (step 1300). The different nodes of interest may depend on a selection, a query, or a default selection. For example, the hypergraph may include thousands of object nodes, edge nodes, and influence nodes.

The visualization may only require a portion of the hypergraph. For example, if the query is made with respect to a particular location or department, only a portion of the object nodes, edge nodes, and influence nodes relating to the location or department may be needed for the visualization.

The process then generates vertices, edges, and associations using the object nodes, edge nodes, and influence nodes (step 1302). The vertices, edges, and associations are graphical elements that may be displayed. The generation of the vertices, edges, and associations may also include any text or other indicators needed for identification in the visualization.

The process determines whether a group of graphical indicators are needed for the influence nodes (step 1304). A group of graphical indicators may be needed if the results of a query identify one or more influence nodes. As used herein, “a group of”, when used with reference items, means one or more items. For example, “a group of graphical indicators” is one or more graphical indicators.

The process assigns the group of graphical indicators to one or more of the influence nodes if a group of graphical indicators is needed (step 1306). In this illustrative example, an influence node may have more than one graphical indicator depending on the implementation. The process displays the hypergraph using the vertices, edges, associations, and any graphical indicators in a graphical user interface on a display system (step 1308), with the process terminating thereafter.

With reference again to step 1304, if graphical indicators are not needed, the process proceeds to step 1308 as described above. In this case, an influence has not been found for the skill. As a result, a graphical indicator is not needed.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order as noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

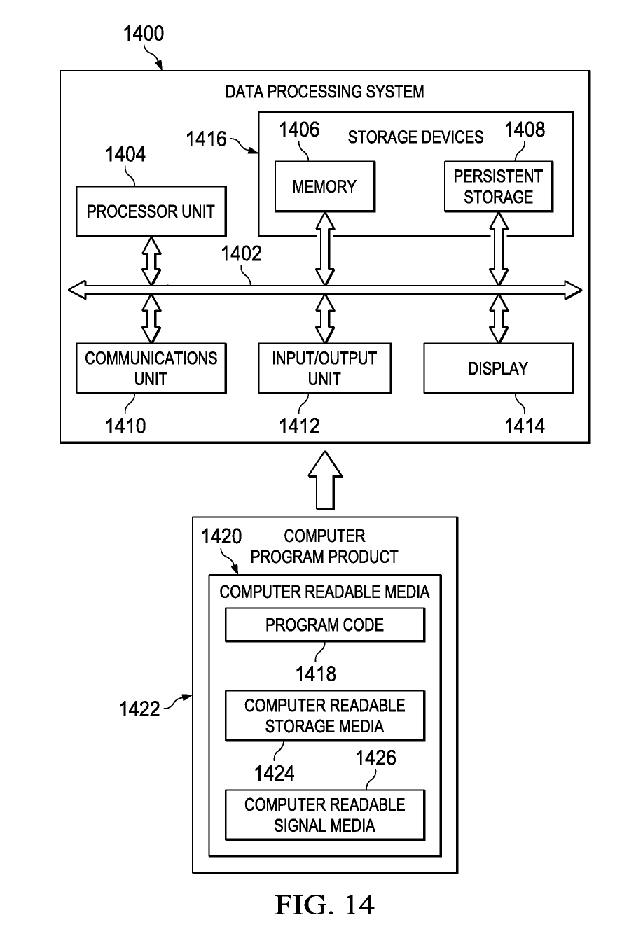

Turning now to FIG. 14, a block diagram of a data processing system is depicted in accordance with an illustrative embodiment. Data processing system 1400 may be used to implement computer system 138 in FIG. 1.

In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 may take the form of a bus system.

Processor unit 1404 serves to execute instructions for software that may be loaded into memory 1406. Processor unit 1404 may be a number of processors, a multi-processor core, or some other type of processor, depending on the particular implementation.

Memory 1406 and persistent storage 1408 are examples of storage devices 1416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1416 may also be referred to as computer readable storage devices in these illustrative examples. Memory 1406, in these examples, may be, for example, a random access memory or any other suitable volatile or non-volatile storage device. Persistent storage 1408 may take various forms, depending on the particular implementation.

For example, persistent storage 1408 may contain one or more components or devices. For example, persistent storage 1408 may be a hard drive, a solid state hard drive, a flash memory, a rewritable optical disk, a rewritable magnetic tape, or some combination of the above. The media used by persistent storage 1408 also may be removable. For example, a removable hard drive may be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that may be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs may be located in storage devices 1416, which are in communication with processor unit 1404 through communications framework 1402. The processes of the different embodiments may be performed by processor unit 1404 using computer-implemented instructions, which may be located in a memory, such as memory 1406.

These instructions are referred to as program code, computer usable program code, or computer readable program code that may be read and executed by a processor in processor unit 1404. The program code in the different embodiments may be embodied on different physical or computer readable storage media, such as memory 1406 or persistent storage 1408.

Program code 1418 is located in a functional form on computer readable media 1420 that is selectively removable and may be loaded onto or transferred to data processing system 1400 for execution by processor unit 1404. Program code 1418 and computer readable media 1420 form computer program product 1422 in these illustrative examples. In one example, computer readable media 1420 may be computer readable storage media 1424 or computer readable signal media 1426. In these illustrative examples, computer readable storage media 1424 is a physical or tangible storage device used to store program code 1418 rather than a medium that propagates or transmits program code 1418.

Alternatively, program code 1418 may be transferred to data processing system 1400 using computer readable signal media 1426. Computer readable signal media 1426 may be, for example, a propagated data signal containing program code 1418. For example, computer readable signal media 1426 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1400 are not meant to provide architectural limitations to the manner in which different embodiments may be implemented. The different illustrative embodiments may be implemented in a data processing system, including components in addition to or in place of those illustrated for data processing system 1400. Other components shown in FIG. 14 can be varied from the illustrative examples shown. The different embodiments may be implemented using any hardware device or system capable of running program code 1418.

Thus, the illustrative embodiments provide a method and apparatus for managing skills in an organization. The managing of skills may include at least one of identifying skills, selecting teams based on skills, generating hiring requirements, assigning people to departments, assigning people to locations, suggesting continuing education classes, and other suitable operations based on the skills. A method and apparatus overcome a technical problem with identifying relevant skills in an organization.

A skill analyzer provides an ability to identify relevant skills. For example, the skill analyzer may use influence nodes to identify skills that occur as a result of other connections between objects in an organization. For example, queries may be made to identify skills that may be needed for a position, a team, a particular manager, or for some other reason. Further, queries may also be made to identify skills to increase productivity or advancement of people in an organization.

Although described with respect to influences on skills, other illustrative embodiments may be directed towards other identifications of influences on other types of objects in a hypergraph. As an example, influences on people by other people, with respect to decision-making, may be identified and included in a hypergraph.

For example, when the influence of a first person on a second person, with respect to purchases, is identified, that type of information may be used to target advertising to people using social networks, visiting websites, and other online activities. As another example, a first person commenting on an article or an advertisement for a product may influence a second person to read the article or look at purchasing that product. As a result, knowing the influence of the first person on the second person may be used to place comments in a particular order for the second person when the article or advertisement is displayed to the second person.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features, as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An information management system comprising:
a hypergraph comprising influence objects; edges, wherein a first portion of the edges connect influence objects to objects for people in an organization and a second portion of the edges connect the influence objects to the objects for skills for the people; and a group of influence edges connecting the first portion of the edges to the second portion of the edges to each other in which the group of influence edges are for a group of influences on the skills present in an organization; and
a skill analyzer that identifies the group of influences on a skill in the skills in the organization using on a group of influence objects in the hypergraph, enabling performing an operation for the organization based on the influences on the skills identified.

2. The information management system of claim 1, wherein the influence objects and the objects are stored as object nodes in a database, the edges are stored as edge nodes in the database, and the group of influence edges is stored as a group of influence nodes in the database.

3. The information management system of claim 1, wherein the skill analyzer receives a query about an influence on the skill in the organization; searches the hypergraph for an influence node for the skill based on the query; and returns a reply identifying the influence on the skill using the influence node for the skill when the influence node is present for the skill.

4. The information management system of claim 1, wherein an edge node in the edge nodes include an identifier, a source node identifier, a target node identifier, and an edge type.

5. The information management system of claim 1 further comprising:
a display system, wherein the skill analyzer is in communication with the display system and displays a visualization of the hypergraph with a group of graphical indicators identifying the first portion of the edges that influence the second portion of the edges for the skill based on the influence objects.

6. The information management system of claim 1, wherein object nodes further represent at least one of a location, a team, a position, or a department.

7. The information management system of claim 1, wherein the skill analyzer performs the operation for the organization based on the influences on the skills identified.

8. The information management system of claim 1, wherein an influence node in the influence nodes includes a first edge identifier, a second edge identifier, and a level of influence.

9. The information management system of claim 1, wherein the operation is selected from one of a hiring for a position, selecting the skills desirable for a new position, making a hiring recommendation, assigning people to project, assigning people to a team, benefits administration, payroll, and assigning a research project.

10. A method for identifying skills in an organization, the method comprising:
representing, by a computer system, people and the skills for the people as objects and a group of influencers on the skills as influence objects in a hypergraph;
forming, by the computer system, edges between the influence objects and the objects for the people and between the objects for the people and the objects for the skills for the people in the hypergraph;
forming, by the computer system, a group of influences edges connecting the edges to each other based on the group of influences the influencers have on the skills for the people; and
identifying, by the computer system, the group of influence on a skill in the skills using a group of influence objects in the hypergraph, enabling performing an operation for the organization based on the influences on the skills for the people in the organization using influence nodes.

11. The method of claim 10 further comprising:
receiving, by the computer system, a query about an influence on the skill in the organization;
searching, by the computer system, the hypergraph for an influence edge for the skill; and
returning, by the computer system, a reply identifying the influence on the skill.

12. The method of claim 11, wherein the reply comprises the hypergraph with a graphical indicator identifying a first portion of the edges that influence a second portion of the edges for the skill based on the influence nodes.

13. The method of claim 10, wherein identifying the influence edges between the edges based on the influences between the edges comprises:
identifying, by the computer system, the influence edges between the edges based on the influences between the edges using at least one of user input or statistical analysis.

14. The method of claim 10 further comprising:
performing the operation for the organization based on the influences.

15. The method of claim 10 further comprising:
displaying the hypergraph on a display system.

16. The method of claim 10 further comprising:
storing the objects as object nodes in a database, the edges as edge nodes in the database, and the group of influence edges a group of influence nodes in the database.

17. The method of claim 10, wherein an edge node in edge nodes include an identifier, a source node identifier, a target node identifier, and a type of connection between a source node and a target node.

18. The method of claim 10 further comprising:
displaying the hypergraph with graphical indicators identifying the influence edges that influence other edges based on the influence nodes.

19. The method of claim 10, wherein object nodes further represent at least one of a location, a position, a team, or a department.

20. The method of claim 15, wherein an influence node in the influence nodes includes a first edge identifier, a second edge identifier, and a level of influence.

21. A computer program product for identifying skills, the computer program product comprising:
a computer readable storage media;
first program code, stored on the computer readable storage media, for representing people and the skills for the people as objects and a group of influencers on the skills as influence objects in a hypergraph;
second program code, stored on the computer readable storage media, for forming edges between the influence objects and the objects for people and between the objects for the people and the objects for the skills for the people in the hypergraph;
third program code, stored on the computer readable storage media, for forming a group of influences edges connecting the edges to each other based on the group of influences the influencers have on the skills for the people; and
fourth program code, stored on the computer readable storage media, for identifying the group of influences on a skill in the skills in an organization using a group of influence objects in the hypergraph, enabling performing an operation for the organization based on the influences on the skills for the people in the organization using influence nodes.

22. The computer program product of claim 21 further comprising:
fifth program code, stored on the computer readable storage media, for receiving a query about the influence on the skill in the organization;
sixth program code, stored on the computer readable storage media, for searching the hypergraph for a group of the influence edges for the skill; and
seventh program code, stored on the computer readable storage media, for returning a reply identifying the influence on the skill.

23. The computer program product of claim 22, wherein the reply comprises the hypergraph with a group of graphical indicators identifying a first portion of the edges that influence a second portion of the edges for the skill based on a group of influence edges.

24. The computer program product of claim 21, wherein the influence is identified using at least one of user input or statistical analysis.

25. The computer program product of claim 21 further comprising:
fifth program code, stored on the computer readable storage media, for displaying the hypergraph with graphical indicators identifying the influence edges that influence other edges based on the influence nodes.
